(19) United States
(12) Patent Application Publication
(10) Pub. No.: US 2010/0166007 A1
(43) Pub. Date: Jul. 1, 2010

(54) Advanced Elastic Time Recovery Mechanism Using Wildcard Searches

(76) Inventor: Jeremy Horner, Nottingham, MD (US)

Correspondence Address: ERICSSON INC., 6300 LEGACY DRIVE, M/S EVR 1-C-11, PLANO, TX, 75024, US

(21) Appl. No.: 12/346,369

(22) Filed: Dec. 30, 2008

(51) Int. Cl. H04L 12/43

(52) U.S. Cl. 370/458

(57) ABSTRACT

A scheduler for a server includes a timestamp associative array for storing timestamps. The scheduler includes an advanced elastic time recovery mechanism having a processor in communication with the associative array which uses a wildcard search to find at least one timestamp in the associative array to schedule for service by the server in a single search, and to increment operational time by more than 1 in a given clock cycle. A method of using a scheduler for a server includes the steps of storing timestamps in a timestamp associative array. There is the step of using a wildcard search of an advanced elastic time recovery mechanism having a processor in communication with the associative array to find a timestamp in the associative array to schedule for service by the server in a single search. There is the step of incrementing operational time by more than 1 in a given clock cycle.

### FIELD OF THE INVENTION

The present invention is related to using a wildcard search in an associative array storing timestamps to find a timestamp in the associative array to schedule for service by the server in a single search. (As used herein, references to the “present invention” or “invention” relate to exemplary embodiments and not necessarily to every embodiment encompassed by the appended claims.) More specifically, the present invention is related to using a wildcard search in an associative array storing timestamps to find a timestamp in the associative array to schedule for service by the server in a single search and to increment operational time by more than 1 in a given clock cycle where a search mask along with a search key equal to operational time is used to search for a desired range of timestamps.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

This invention is closely related to the invention disclosed in U.S. patent application Ser. No. 12/215,467 entitled “Improving Network Traffic Schedulers with an Associative Array,” incorporated by reference herein (the '467 application). That invention focused on using an associative array to improve network traffic schedulers, and provides nearly all of the necessary background information for this invention. The focus of this invention (and therefore the focus of this invention disclosure) is to improve on the basic elastic time recovery mechanism which was described in the '467 application.

Some of the most essential background information is provided here, but the '467 application can be read as well in order to gain a more complete understanding. This document assumes, in general, that an associative array is being used by the scheduler to store timestamps, and that the scheduler searches that associative array in order to locate any and all rate groups that are eligible to be scheduled during the current time.

Timestamps

The scheduler uses timestamps to track the scheduling eligibility of each Virtual Link and each Rate Group by storing the next time that it can be scheduled. The timestamp is calculated using the programmed bandwidth and the time that the VL or RG was last scheduled. Each time that the port sequencer informs the scheduler that a port is eligible to be scheduled, the scheduler examines the timestamps stored for the Virtual Links and Rate Groups belonging to that port and determines if any are eligible to be scheduled during the current time slot. This is done by examining the scheduler's internal time counter and comparing its value to the value stored for the RGs and VLs. If a match is found, then that RG or VL is eligible to be scheduled at the current time slot.

Elastic Time

When is Elastic Time needed?

The scheduler searches the timestamps in order to determine the most eligible Rate Group to be scheduled during the current scheduling slot, but it is possible for the search to result in multiple equally eligible Rate Groups. The scheduler needs a mechanism to gracefully recover from this occurring.

Perhaps the simplest solution is to have the scheduler read out all of those matches, buffering them up to be sent out during future scheduling slots. But, even if this method is used, it is possible that when the time comes for the scheduler to search for eligible RGs at this new time, that it is still reading out and buffering multiple matches from the previous search. It is not possible to initiate a new search with the new time until all of the previous matches were read out and buffered. It is this type of scenario where elastic time is needed.

What is Elastic Time?

Elastic time uses 2 internal clocks, one is used to track the ideal time and one is used to track the current operational time. If the time has come for the clock to be incremented, but the search results are still being read out, then the ideal time will still be incremented while the current operational time will remain unchanged until the search results have been read. Once they have been read, the scheduler will start accelerating the operational time in order to catch up to the ideal time. The term “elastic time” is used because the operating time can slow down or speed up as necessary relative to the ideal time in order to finish the required operations.

Implementing the Elastic Time Recovery Mechanism

A basic elastic time recovery mechanism (which is described in U.S. patent application Ser. No. 12/215,467, incorporated by reference herein) can be created that takes advantage of the fact that more than one search of the timestamp array can be completed during each scheduling interval. This means that it is possible for time to speed back up (i.e. the operational time can begin to increment at a faster rate than the ideal time) by performing multiple searches of the array during a scheduling interval.

This basic implementation is illustrated in FIG. 1. In the example, a new timestamp search can be initiated every clock cycle, but the Ideal Time only increments every 3^{rd} clock cycle. The scheduler can tolerate up to 3 matches for a given search without initiating the elastic time recovery mechanism. If the number of matches is greater than the time period (measured in # of clock cycles), then the Operational Time starts to fall behind the Ideal Time. When a given search results in fewer than 3 matches (in this example), Operational Time can speed up by issuing a new search each available clock cycle until it equals the Ideal Time once again. Note that using this basic approach to Elastic Time Recovery results in the Operational Time falling behind the Ideal Time at clock cycle 9 and equaling the Ideal Time at clock cycle 23.

TABLE 1
Example of Basic Elastic Time Recovery Mechanism

| | | | | # of | | |
|---|---|---|---|---|---|---|
| | | | | Matches | ELASTIC | |
| Clock | Ideal | Operational | Timestamp | Remaining | Time | |
| Cycle | Time | Time | Search | to Read | Difference | Comments |
| 0 | 0 | 0 | 0 | 1 | | The single search result is read out |
| | | | | | | long before the ideal time |
| | | | | | | increments. |
| 1 | 0 | 0 | | 0 | | |
| 2 | 0 | 0 | | 0 | | |
| 3 | 1 | 1 | 1 | 3 | | Multiple matches result from the |
| | | | | | | search, but we still have time to |
| | | | | | | read them all out before the ideal |
| | | | | | | time increments |
| 4 | 1 | 1 | | 2 | | |
| 5 | 1 | 1 | | 1 | | |
| 6 | 2 | 2 | 2 | 10 | | |
| 7 | 2 | 2 | | 9 | | |
| 8 | 2 | 2 | | 8 | | |
| 9 | 3 | 2 | | 7 | 1 | Ideal time increments, but results |
| | | | | | | are still being read resulting in time |
| | | | | | | becoming elastic. The Operational |
| | | | | | | Time falls behind the Ideal Time by |
| | | | | | | 1 clock tick. |
| 10 | 3 | 2 | | 6 | 1 | |
| 11 | 3 | 2 | | 5 | 1 | |
| 12 | 4 | 2 | | 4 | 2 | Operational Time falls further |
| | | | | | | behind because results are still |
| | | | | | | being read |
| 13 | 4 | 2 | | 3 | 2 | |
| 14 | 4 | 2 | | 2 | 2 | |
| 15 | 5 | 2 | | 1 | 3 | Operational Time falls further |
| | | | | | | behind because results are still |
| | | | | | | being read |
| 16 | 5 | 3 | 3 | 0 | 2 | Now that the results have all been |
| | | | | | | read, we can begin to speed up time |
| | | | | | | again to catch up to the ideal time. |
| | | | | | | NOTE: This lookup was wasted |
| | | | | | | since it did not return a match. |
| 17 | 5 | 4 | 4 | 0 | 1 | We continue to increment |
| | | | | | | Operational Time in order to catch |
| | | | | | | up, and again this lookup was |
| | | | | | | wasted with no match returned. |
| 18 | 6 | 5 | 5 | 4 | 1 | We receive multiple matches and |
| | | | | | | were not able to increment |
| | | | | | | Operational Time as the Ideal Time |
| | | | | | | incremented. |
| 19 | 6 | 5 | | 3 | 1 | |
| 20 | 6 | 5 | | 2 | 1 | |
| 21 | 7 | 5 | | 1 | 2 | Elastic Time Difference increases |
| 22 | 7 | 6 | 6 | 1 | 1 | A match was received and |
| | | | | | | Operational Time is catching up to |
| | | | | | | Ideal Time |
| 23 | 7 | 7 | 7 | 1 | | Operational Time has now caught- |
| | | | | | | up to match the Ideal Time |

Although this implementation of elastic time will allow the scheduler to gracefully recover from multiple matches being found while searching the timestamp associative array, it has inefficiencies which can be improved upon.

One significant drawback to the basic implementation of elastic time is that there is no guarantee that the search will find a valid match. If no match is found, then that search was wasted. Even if the difference between the ideal time and the current operational time were to grow very large, there is no way to accelerate the recovery mechanism.

### BRIEF SUMMARY OF THE INVENTION

The present invention pertains to a scheduler for a server. The scheduler comprises a timestamp associative array for storing timestamps. The scheduler comprises an advanced elastic time recovery mechanism having a processor in communication with the associative array which uses a wildcard search to find at least one timestamp in the associative array to schedule for service by the server in a single search, and to increment operational time by more than 1 in a given clock cycle.

The present invention pertains to a method of using a scheduler for a server. The method comprises the steps of storing timestamps in a timestamp associative array. There is the step of using a wildcard search of an advanced elastic time recovery mechanism having a processor in communication with the associative array to find at least one timestamp in the associative array to schedule for service by the server in a single search. There is the step of incrementing operational time by more than 1 in a given clock cycle.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of the present invention.

FIG. 2 is an example of a binary wildcard search using mask.

FIG. 3 is an Advanced Elastic Time Flowchart.

### DETAILED DESCRIPTION OF THE INVENTION

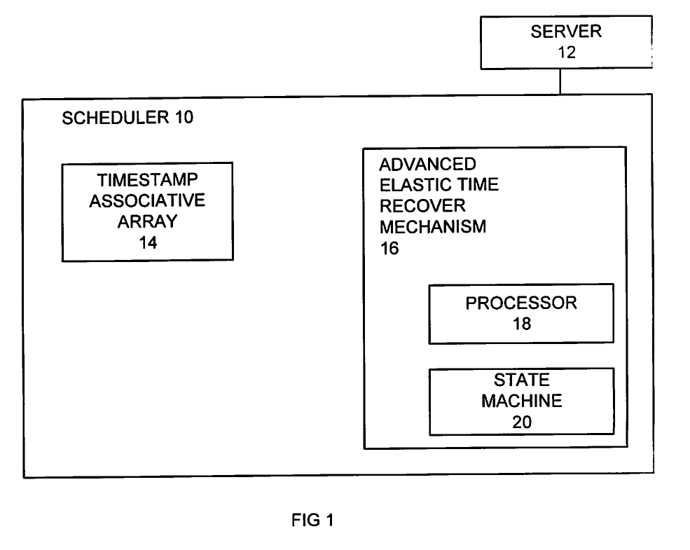

Referring now to the drawings wherein like reference numerals refer to similar or identical parts throughout the several views, and more specifically to FIG. 1 thereof, there is shown a scheduler 10 for a server 12. The scheduler 10 comprises a timestamp associative array 14 for storing timestamps. The scheduler 10 comprises an advanced elastic time recovery mechanism 16 having a processor 18 in communication with the associative array 14 which uses a wildcard search to find at least one timestamp in the associative array 14 to schedule for service by the server 12 in a single search, and to increment operational time by more than 1 in a given clock cycle. The server can be for instance a switch or router, but is not limited thereto.

Preferably, the advanced elastic time recovery mechanism 16 includes a state machine 20 which monitors ideal time and operational time and calculates an elastic time difference (ETD) according to a formula:

ETD=ideal time−operational time.

When the ETD equals zero, the state machine 20 preferably searches the timestamp associative array 14 for a next eligible time by initiating a search using a timestamp search key equal to the operational time and a search mask equal to all 1s. Preferably, when the ETD is greater than zero the wildcard search uses a wildcard search pattern composed of a search value and the search mask that the advanced elastic time recovery mechanism 16 uses to cover not only the operational time, but also the greatest possible range of numbers between the operational time and the ideal time.

The wildcard search preferably determines the maximum number of timestamps that can be searched for, where the maximum number of timestamps is found by taking the ETD and rounding it down to a nearest power of 2. Preferably, the wildcard search assumes that that the range of timestamps that is valid for searching does not include any timestamps that have already been searched for. The wildcard search preferably determines that the operational time is divisible by 2, and in order to search the largest range of numbers, the wildcard search determines a largest divisor which equals 2 raised to the power of the number of least significant bits that are zero.

Preferably, the wildcard searches for the maximum number of time stamps if the operational time equals zero, or chooses a smallest value of the maximum number of timestamps and the largest power of 2 divisor of operational time when the operational time does not equal zero; where the result is defined as the number of timestamps. The search mask is preferably formed by raising 2 to the power of (the number of timestamps −1), and doing a binary bitwise inversion of the search mask; the search mask along with a search key equal to the operational time is used to search for the desired range of timestamps.

The present invention pertains to a method of using a scheduler 10 for a server 12. The method comprises the steps of storing timestamps in a timestamp associative array 14. There is the step of using a wildcard search of an advanced elastic time recovery mechanism 16 having a processor 18 in communication with the associative array 14 to find at least one timestamp in the associative array 14 to schedule for service by the server 12 in a single search. There is the step of incrementing operational time by more than 1 in a given clock cycle.

Preferably, there are the steps of monitoring ideal time and operational time with a state machine 20 of the advanced elastic time recovery mechanism 16; and calculating an elastic time difference (ETD) according to a formula:

ETD=ideal time−operational time.

When the ETD equals zero, there is preferably the step of the state machine 20 searching the timestamp associative array 14 for a next eligible time by initiating a search using a timestamp search key equal to the operational time and a search mask equal to all 1s. Preferably, when the ETD is greater than zero there is the step of the wildcard search using a wildcard search pattern composed of a search value and the search mask that the advanced elastic time recovery mechanism 16 uses to cover not only the operational time, but also the greatest possible range of numbers between the operational time and the ideal time. The step of using the wildcard search preferably includes the step of the wildcard search determining the maximum number of timestamps that can be searched for, where the maximum number of timestamps is found by taking the ETD and rounding it down to a nearest power of 2.

Preferably, the step of using the wildcard search includes the step of the wildcard search assuming that that the range of timestamps that is valid for searching does not include any timestamps that have already been searched for. The step of using the wildcard search preferably includes the steps of the wildcard search determining that the operational time is divisible by 2, and in order to search the largest range of numbers, the wildcard search determining a largest divisor which equals 2 raised to the power of the number of least significant bits that are zero.

Preferably, the step of using the wildcard search includes the step of using the wildcard search to search for the maximum number of time stamps if the operational time equals zero, or choosing a smallest value of the maximum number of timestamps and the largest power of 2 divisor of operational time when the operational time does not equal zero; where the result is defined as the number of timestamps. There is preferably the steps of forming the search mask by raising 2 to the power of (the number of timestamps -1), and doing a binary bitwise inversion of the search mask; the search mask along with a search key equal to the operational time is used to search for the desired range of timestamps.

In the operation of the invention, it is desired to significantly reduce the number of wasted searches and to accelerate the return of the operational time to the ideal time in the event.

This can be accomplished by using wild-card searches as part of an advanced elastic time recovery mechanism 16. When the Operational Time is behind the Ideal Time, there is a range of timestamps which are eligible to schedule during the present time slot. Using a wildcard search allows one to search either the entire range or a significant portion of that in a single search. Doing this allows one to increment operational time by more than 1 in a given clock cycle which allows the system to return to the normal time quicker.

Before discussing how the wildcard search pattern is determined, it would be helpful to explain how a wildcard search can be performed for a binary number using a search value and a search mask.

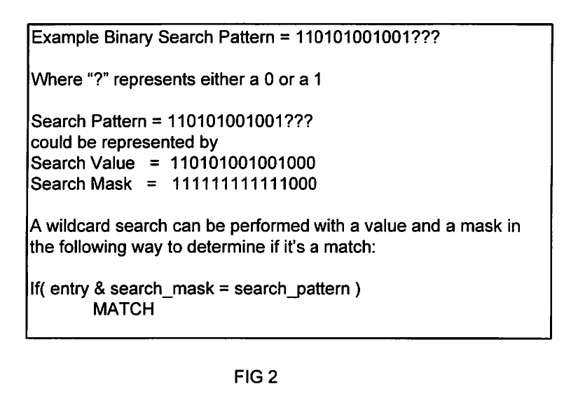

In the example shown in FIG. 2, the search pattern of “110101001001??” would search the entire range of binary numbers from “110101001001000” to “110101001001111”.

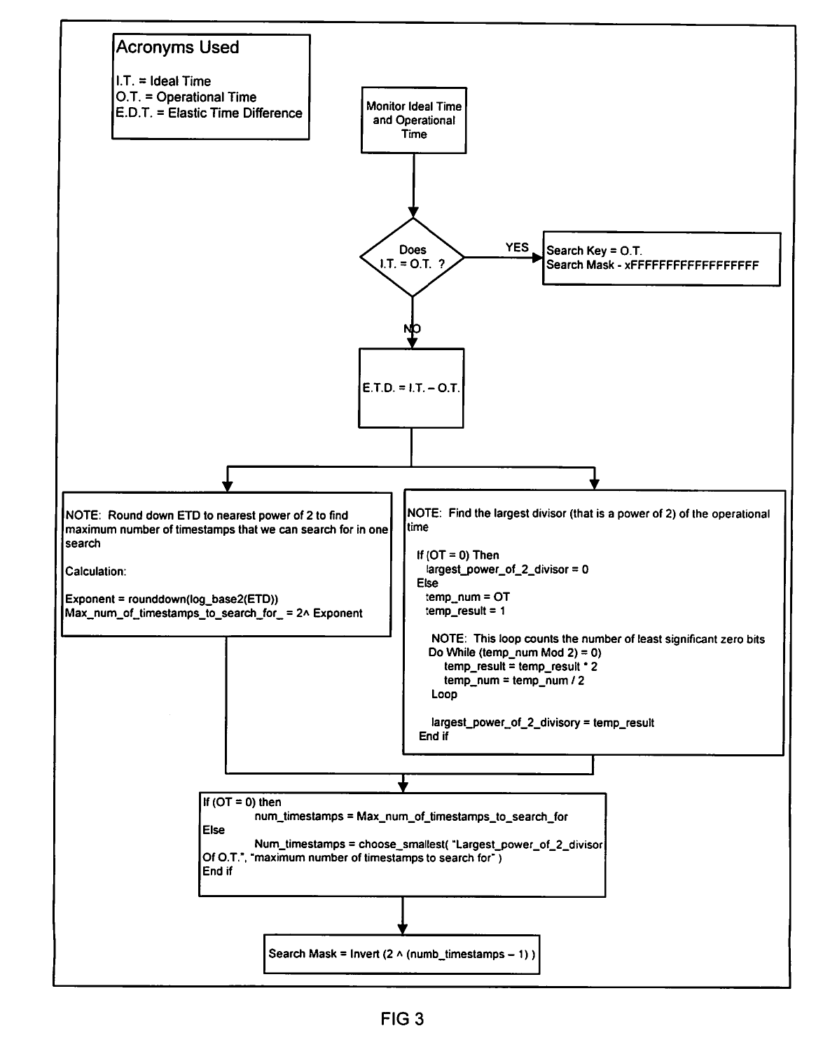

This invention uses wildcard searching to speed up elastic time recovery. At the heart of the invention is the algorithm used to calculate the search mask. The search mask, which is calculated according to the algorithm shown in FIG. 3, is used along with a search value equal to the Operational Time to search the desired range of timestamps.

The following is an explanation of the algorithm shown in FIG. 3.

The state machine 20 for an advanced elastic time recovery mechanism 16 monitors the Ideal Time and the Operational Time and calculates the Elastic Time Difference (ETD) using the following formula:

ETD=Ideal Time−Operational Time

Under normal circumstances, the ETD will equal zero, and the state machine 20 will search the timestamp associative array 14 for the next eligible time by initiating a search using a timestamp search key equal to the Operational Time and a search mask equal to all 1's.

If the ETD is greater than zero (that is the Ideal Time is greater than the Operational Time), an algorithm is used to find the wildcard search pattern (composed of a search value and a search mask) that the Advanced Elastic Time Recovery mechanism 16 should use to cover not only the Operational Time, but also the greatest possible range of numbers between the Operation Time and the Ideal Time. Ideally, the entire range of numbers between the Operational Time and the Ideal Time would be covered with a single search, but this may not be possible in every circumstance.

The algorithm must first determine the maximum number of timestamps that can be searched for. This number is found by taking the Elastic Time Difference (ETD) and rounding it down to the nearest power of two. The generic formula for this would be to take the base 2 logarithm of the ETD, round the resulting exponent down to the nearest integer, and then raise 2 to that power to find the maximum number of timestamps that can be searched for in one search. The binary calculation is simpler since it does not involve floating point calculations. You can simply take the most significant bit that is a ‘1’ and make all of the least significant bits ‘0’. After doing that, you'll have the maximum number of timestamps that can be searched for at one time.

This algorithm assumes that the range of timestamps that is valid for searching does not include any timestamps that have already been searched for. The reason for this is that because the timestamps wrap back to zero at their maximum value, a timestamps that is in the past can also be considered very far in the future. This can occur if the time increment for a given connection is close to the maximum number of bits used to store the timestamp. If, however, the algorithm can ensure that the timestamps in the recent past will not be reused for the distant future (which can be done by limiting the maximum time increment size), then this search algorithm could always search for the maximum number of timestamps as determined in the previous step.

FIG. 3 shows the most general case which will be discussed here. If we assume that nothing before the Operational Time (O.T.) can be included in a search, then the O.T. must be examined to determine if it's eligible for a wildcard search. It is valid, if it's divisible by 2. But, in order to search the largest range of numbers, the algorithm must determine the largest divisor (that is a power of 2). The largest divisor equals 2 raised to the power of the number of least significant bits that are zero.

The algorithm then makes the final determination of the number of timestamps to search for. If the Operational Time equals zero, then the algorithm can search for the maximum number of timestamps. Otherwise, it has to choose the smallest value of the maximum number of timestamps and the largest_power_of_{—}2_divisor_of_OT. The result of this choice is referred to in FIG. 3 as num_timestamps.

The search mask is then formed by raising 2 to the power of (num_timestamps_{—}1), and doing the binary bitwise inversion of that number.

This search_mask along with a search key equal to the operational time will search for the desired range of timestamps.

FIG. 4 shows an example of an Advanced Elastic Time Recovery mechanism 16. This approach builds on the basic approach by also taking advantage of wild card searches which are available in a ternary CAM or more generically, in a ternary associative array 14. Note that in FIG. 4, the search for timestamp 3 and the search for timestamp 4 both resulted in zero matches. With the ability to do a wild card search, it is possible to initiate a search at clock cycle 17 for both timestamp 4 and timestamp 5 (searching for the binary value 10? (where ‘?’ represents a “don't care”) which searches for both 100 and 101 simultaneously). This avoids the wasted search for timestamp 4 and allows us to have Operational Time equal Ideal Time at clock cycle 17 (6 cycles sooner than using the basic approach).

The advantage of this approach would increase significantly in proportion to an increase in the Elastic Time Difference. For example, if the Ideal Time was equal to the binary value “01111” and the Operational Time was equal to the binary value “00111”, the scheduler 10 could search for “01???” in one search covering the entire Elastic Time Difference.

Table 2 shows an example of an Advanced Elastic Time Recovery mechanism 16. This approach builds on the basic approach by also taking advantage of wild card searches which are available in a ternary CAM or more generically, in a ternary associative array 14. Note that in Table 2, the search for timestamp 3 and the search for timestamp 4 both resulted in zero matches. With the ability to do a wild card search, it is possible to initiate a search at clock cycle 17 for both timestamp 4 and timestamp 5 (searching for the binary value 10? (where ‘?’ represents a “don't care”) which searches for both 100 and 101 simultaneously). This avoids the wasted search for timestamp 4 and allows one to have Operational Time equal Ideal Time at clock cycle 17 (6 cycles sooner than using the basic approach).

TABLE 2
Example of Advanced Elastic Time Recovery Mechanism

| | | | | # of | | |
|---|---|---|---|---|---|---|
| | | | | Matches | ELASTIC | |
| Clock | Ideal | Operational | Timestamp | Remaining | Time | |
| Cycle | Time | Time | Search | to Read | Difference | Comments |
| 0 | 0 | 0 | 0 | 1 | | The single search result is read out |
| | | | | | | long before the ideal time |
| | | | | | | increments. |
| 1 | 0 | 0 | | 0 | | |
| 2 | 0 | 0 | | 0 | | |
| 3 | 1 | 1 | 1 | 3 | | Multiple matches result from the |
| | | | | | | search, but we still have time to |
| | | | | | | read them all out before the ideal |
| | | | | | | time increments |
| 4 | 1 | 1 | | 2 | | |
| 5 | 1 | 1 | | 1 | | |
| 6 | 2 | 2 | 2 | 10 | | |
| 7 | 2 | 2 | | 9 | | |
| 8 | 2 | 2 | | 8 | | |
| 9 | 3 | 2 | | 7 | 1 | Ideal time increments, but results |
| | | | | | | are still being read resulting in time |
| | | | | | | becoming elastic. The Operational |
| | | | | | | Time falls behind the Ideal Time by |
| | | | | | | 1 clock tick. |
| 10 | 3 | 2 | | 6 | 1 | |
| 11 | 3 | 2 | | 5 | 1 | |
| 12 | 4 | 2 | | 4 | 2 | Operational Time falls further |
| | | | | | | behind because results are still |
| | | | | | | being read |
| 13 | 4 | 2 | | 3 | 2 | |
| 14 | 4 | 2 | | 2 | 2 | |
| 15 | 5 | 2 | | 1 | 3 | Operational Time falls further |
| | | | | | | behind because results are still |
| | | | | | | being read |
| 16 | 5 | 3 | 3 | 0 | 2 | Now that the results have all been |
| | | | | | | read, we can begin to speed up time |
| | | | | | | again to catch up to the ideal time. |
| | | | | | | NOTE: This lookup was wasted |
| | | | | | | since it did not return a match. |
| 17 | 5 | 5 | 4-5 (binary | 4 | 1 | The wildcard search feature can be |
| | | | value = | | | used to search for more than one |
| | | | “10?”) | | | timestamps simultaneously allowing |
| | | | | | | Operational Time to catch up to |
| | | | | | | Ideal Time sooner. |
| 18 | 6 | 5 | | 3 | 1 | |
| 19 | 6 | 5 | | 2 | 1 | |
| 20 | 6 | 5 | | 1 | 1 | |
| 21 | 7 | 6 | 6 | 1 | 1 | |
| 22 | 7 | 7 | 7 | 1 | | |
| 23 | 7 | 7 | | 0 | | |

It is desirable for the scheduler's 10 operational time to stay as close as possible to the scheduler's 10 ideal time. The advanced elastic time recovery mechanism 16 described in this invention achieves this by effectively limiting how far the operational time can drift from the ideal time.

Another way that the invention improves the scheduler 10 is by making it more efficient. By reducing the number of wasted timestamp searches, the invention is also reducing the total number of timestamp searches required to schedule a given amount of traffic. This effectively increases the average number of searches that can occur during a period of time, resulting in a more efficient and faster scheduler 10.

Abbreviations

CAM=Content Addressable Memory.

RG=Rate Group

Ternary CAM=This is a type of CAM that allows for 3 states to be stored for each bit: 1, 0, and ‘?’ (don't care). This type of CAM also provides the capability to do wild card searches using Global Mask Registers.

VL=Virtual Link

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A scheduler for a server comprising:
a timestamp associative array for storing timestamps; and
an advanced elastic time recovery mechanism having a processor in communication with the associative array which uses a wildcard search to find at least one timestamp in the associative array to schedule for service by the server in a single search, and to increment operational time by more than 1 in a given clock cycle.

2. The scheduler as described in claim 1 wherein the advanced elastic time recovery mechanism includes a state machine which monitors ideal time and operational time and calculates an elastic time difference (ETD) according to a formula:
ETD=ideal time−operational time.

3. The scheduler as described in claim 2 wherein when the ETD equals zero, the state machine searches the timestamp associative array for a next eligible time by initiating a search using a timestamp search key equal to the operational time and a search mask equal to all 1's.

4. The scheduler as described in claim 3 wherein when the ETD is greater than zero the wildcard search uses a wildcard search pattern composed of a search value and the search mask that the advanced elastic time recovery mechanism uses to cover not only the operational time, but also the greatest possible range of numbers between the operational time and the ideal time.

5. The scheduler as described in claim 4 wherein the wildcard search determines the maximum number of timestamps that can be searched for, where the maximum number of timestamps is found by taking the ETD and rounding it down to a nearest power of 2.

6. The scheduler as described in claim 5 wherein the wildcard search assumes that that the range of timestamps that is valid for searching does not include any timestamps that have already been searched for.

7. The scheduler as described in claim 6 wherein the wildcard search determines that the operational time is divisible by 2, and in order to search the largest range of numbers, the wildcard search determines a largest divisor which equals 2 raised to the power of the number of least significant bits that are zero.

8. The scheduler as described in claim 7 wherein the wildcard searches for the maximum number of time stamps if the operational time equals zero, or chooses a smallest value of the maximum number of timestamps and the largest power of 2 divisor of operational time when the operational time does not equal zero; where the result is defined as the number of timestamps.

9. The scheduler as described in claim 8 wherein the search mask is formed by raising 2 to the power of (the number of timestamps -1), and doing a binary bitwise inversion of the search mask; the search mask along with a search key equal to the operational time is used to search for the desired range of timestamps.

10. A method of using a scheduler for a server comprising the steps of:
storing timestamps in a timestamp associative array;
using a wildcard search of an advanced elastic time recovery mechanism having a processor in communication with the associative array to find at least one timestamp in the associative array to schedule for service by the server in a single search; and
incrementing operational time by more than 1 in a given clock cycle.

11. The method as described in claim 10 including the steps of monitoring ideal time and operational time with a state machine of the advanced elastic time recovery mechanism; and calculating an elastic time difference (ETD) according to a formula:
ETD=ideal time−operational time.

12. The method as described in claim 11 wherein when the ETD equals zero, there is the step of the state machine searching the timestamp associative array for a next eligible time by initiating a search using a timestamp search key equal to the operational time and a search mask equal to all 1s.

13. The method as described in claim 12 wherein when the ETD is greater than zero there is the step of the wildcard search using a wildcard search pattern composed of a search value and the search mask that the advanced elastic time recovery mechanism uses to cover not only the operational time, but also the greatest possible range of numbers between the operational time and the ideal time.

14. A method as described in claim 13 wherein the step of using the wildcard search includes the step of the wildcard search determining the maximum number of timestamps that can be searched for, where the maximum number of timestamps is found by taking the ETD and rounding it down to a nearest power of 2.

15. The method as described in claim 14 wherein the step of using the wildcard search includes the step of the wildcard search assuming that that the range of timestamps that is valid for searching does not include any timestamps that have already been searched for.

16. The method as described in claim 15 wherein the step of using the wildcard search includes the steps of the wildcard search determining that the operational time is divisible by 2, and in order to search the largest range of numbers, the wildcard search determining a largest divisor which equals 2 raised to the power of the number of least significant bits that are zero.

17. The method as described in claim 16 wherein the step of using the wildcard search includes the step of using the wildcard search to search for the maximum number of time stamps if the operational time equals zero, or choosing a smallest value of the maximum number of timestamps and the largest power of 2 divisor of operational time when the operational time does not equal zero; where the result is defined as the number of timestamps.

18. The method as described in claim 17 including the steps of forming the search mask by raising 2 to the power of (the number of timestamps -1), and doing it binary bitwise inversion of the search mask; the search mask along with a search key equal to the operational time is used to search for the desired range of timestamps.
